(19) United States
(12) Patent Application Publication
(10) Pub. No.: US 2022/0076273 A1
(43) Pub. Date: Mar. 10, 2022

(54) SUPPLY CHAIN TRACKING

(71) Applicant: Radient Technologies Innovations Inc., Edmonton (CA)

(72) Inventors: Michael Cabigon, Edmonton (CA); Jim Seethram, Edmonton (CA); Steven Splinter, North Vancouver (CA); Denis Taschuk, Edmonton (CA)

(21) Appl. No.: 17/238,009

(22) Filed: Apr. 22, 2021

Related U.S. Application Data
(63) Continuation of application No. PCT/IB2019/058954, filed on Oct. 21, 2019.
(60) Provisional application No. 62/749,024, filed on Oct. 22, 2018.
(60) Provisional application No. 62/749,037, filed on Oct. 22, 2018.
(60) Provisional application No. 62/749,040, filed on Oct. 22, 2018.
(60) Provisional application No. 62/757,040, filed on Nov. 7, 2018.

(51) Int. Cl. G06Q 30/00; G06F 16/27; G06F 16/245

(52) U.S. Cl. CPC G06Q 30/018; G06F 16/245; G06F 16/27

(57) ABSTRACT

Systems and methods for tracking seed-to-sale data of an extractable biomass are provided. The system and method comprise a cannabis seed broker, grower, extractor, product manufacturer and retailer of cannabis products. The system and method provide a plurality of sensors to gather seed, plant, extract, manufacturing, and retail data in their respective blockchains. The system and method further provide a third-party verification network, a distributed blockchain network and a user device, wherein, the identities of the cannabis seed broker, grower, extractor, product manufacturer and retailer of cannabis products may be verified using the third-party verification networking. This system and method further determine the best biomass mix along with the processing and handling techniques used to manufacture edible cannabis-infused product based on the seed-to-sale data, as well as historical consumer feedback on the taste and quality of past cannabis products.

### CROSS-REFERENCED TO RELATED APPLICATIONS

The present patent application is a continuation of PCT/IB2019/058954 filed Oct. 21, 2019 which claims the priority benefit of U.S. provisional patent No. 62/749,024 filed Oct. 22, 2018, U.S. provisional patent No. 62/749,037 filed Oct. 22, 2018, U.S. provisional patent No. 62/749,040 filed Oct. 22, 2018, and U.S. provisional patent application No. 62/757,040 filed Nov. 7, 2018, the disclosures of which are incorporated by reference herein.

### BACKGROUND OF THE INVENTION

### 1. Field of the Invention

The present disclosure is generally related to cannabis data tracking. More particularly, the present disclosure is related to tracking the attribute profile of cannabis products from seed to sale.

### 2. Description of the Related Art

Cannabis is a genus of flowering plants in the family Cannabaceae. Three species may be recognized: Cannabis sativa, Cannabis indica, and Cannabis ruderalis; C. ruderalis may be included within C. sativa; or all three may be treated as subspecies of a single species, C. sativa. The term cannabis or “cannabis biomass” encompasses the Cannabis sativa plant and also variants thereof, including subspecies sativa, indica and ruderalis, cannabis cultivars, and cannabis chemovars (varieties characterised by chemical composition), which naturally contain different amounts of the individual cannabinoids, and also plants which are the result of genetic crosses. The term “cannabis biomass” is to be interpreted accordingly as encompassing plant material derived from one or more cannabis plants.

Cannabis has a long history being used for medicinal, therapeutic, and recreational purposes. Historical delivery methods for cannabis have involved smoking (e.g., combusting) the dried cannabis plant material. Alternative delivery methods such as ingesting typically require extracts of the cannabis biomass (i.e., cannabis concentrates or cannabis oils). Often, cannabis extracts are formulated using any convenient pharmacologically or food-grade acceptable diluents, carriers or excipients to produce a composition, which collectively may be known as cannabis derivative products or cannabis products. These may for example include cannabis topicals, edibles, or vaping products. Cannabis edibles may include cannabis-infused food or beverage products.

The ability to transform cannabis into many different products creates a challenge for both producers and consumers to accurately track supply chain data, chain of custody data for security purposes, and application efficacy data, from a cannabis seed, through the growing and harvesting of the biomass, the extraction of active compounds, the manufacture of a cannabis product, to the eventual sale of the product.

### SUMMARY OF THE CLAIMED INVENTION

The present invention includes systems and methods for providing an immutable record of tracking processing, shipping, and sales of an extractable biomass, such as cannabis, from its origin as a seed to its destination as a final product. The present invention further allows for integrating manufacturers of cannabis products to obtain and use product rating data obtained from consumer input, and other manufacturers' products data to determine quality issues through correlation of data. The present invention allows the sharing of data as the data is stored in a database (i.e., blockchain) and allowing an end user to have access to the stream of data as it moves through the supply chain. The invention an immutable record of cannabis data which can be analyzed to determine trends in cannabis biomass, cannabis concentrates, cannabis products, and the sale of cannabis. Contributors to the immutable record are verified independently and the immutable record is distributed and reconciled by multiple network nodes. Blockchain provides a ledger of blocks that are connected based on a mathematical algorithm. The blockchain can be distributed over many users, protecting the ledger from contamination at any individual node.

### BRIEF DESCRIPTIONS OF THE DRAWINGS

FIG. 1 illustrates an exemplary network environment in which a system for tracking cannabis products from seed to sale to consumer rating using a blockchain-based distributed ledger may be implemented.

FIG. 2 is a flowchart illustrating an exemplary method for tracking cannabis products using a blockchain-based distributed ledger.

FIG. 3 is a flowchart illustrating an exemplary method for verification of blockchain-based distributed ledgers regarding cannabis products.

FIG. 4 is a flowchart illustrating an exemplary method for quality control of blockchain-based distributed ledgers regarding cannabis products.

FIG. 5 is a flowchart illustrating an exemplary method for quality correlation using blockchain-based distributed ledgers regarding cannabis products.

FIG. 6 is a flowchart illustrating an exemplary method for product optimization using blockchain-based distributed ledgers regarding cannabis products.

### DETAILED DESCRIPTION

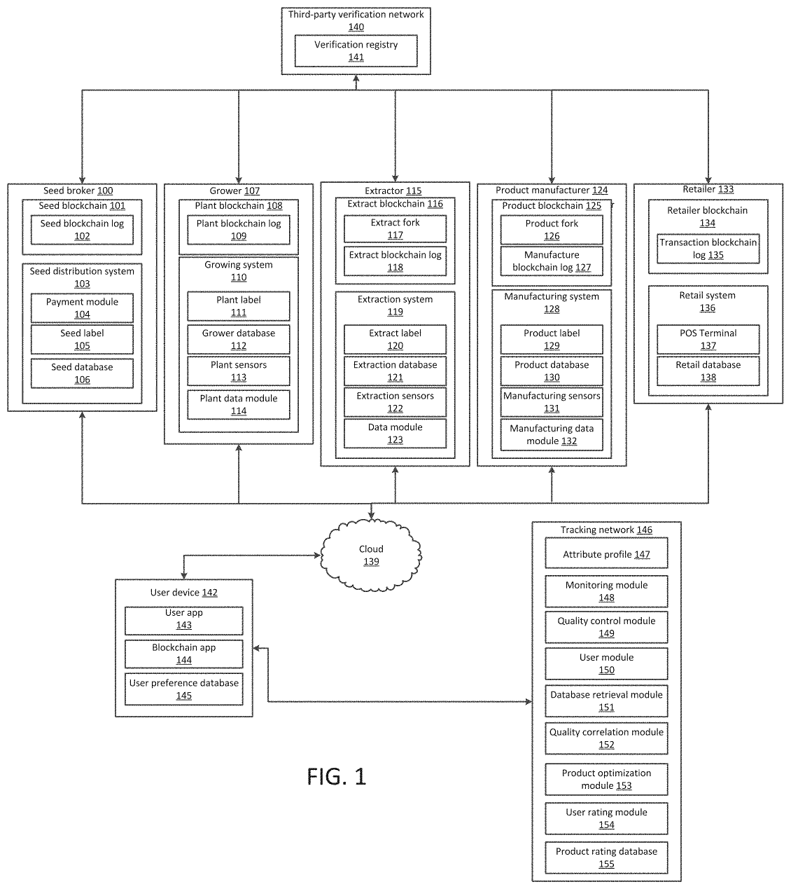

FIG. 1 illustrates an exemplary network environment in which a system for tracking cannabis products from seed to sale to consumer rating using a blockchain-based distributed ledger may be implemented. It should be noted for the purposes of this invention “cannabis” may be substituted with any extractable biomass that may be subject to a supply chain from seed, growth of plant, processing of plant, manufacture of a product, to the sale of said product. In some embodiments, the extractable biomass may include any of flax seed, rosemary, centella, valerian, or fungi, for example. The system is a network of distributed blockchain nodes that compute consensus of the seed, plant, extractor, product, and retailer blockchain. The network facilitates the shipping between seed brokers 100, growers 107, extractors 115, product manufacturers 124, retailers 133, and users, as well as providing associated shipping data, which may include, for example, end point location, transfer of custody, data loggers and shipping manifests, in-transit product state from smart packaging or carrier sensors, carrier, route, and environmental data, in some embodiments, the shipping network may provide sensor data of materials in transit to the blockchain, allowing either the shipper or receiver to monitor or trend shipping conditions by retrieving shipping data from the blockchain. A series of sensors (e.g., plant sensors 113, extraction sensors 122, manufacturing sensors 131, etc.) are at every step of the value chain to develop an attribute profile 147. Sensors that could be used are, but not limited to, chemical sensors and gas analyzers, water sensors, meteorological sensors, weed seekers, optical cameras, light detection and ranging (LIDAR), photometric sensors, soil respiration or moisture, photosynthesis sensors, leaf area index (LAI) sensors, range finders, dendrometers, hygrometers, temperature sensors, RFID tags.

The system comprises a seed broker 100 that supplies cannabis seeds to growers. The system is capable of verifying the identity of the seed broker 100, using a passcode, biometrics, private cryptography key, and receives verification from a third-party verification network. A seed blockchain 101 ledger logs seed data, quality data (e.g., data relating to quality assurance or quality checks) and shipping data (e.g., end point location, transfer of custody, data loggers and shipping manifests, in-transit product state from smart packaging or carrier sensors, carrier, route, and environmental data) at the point of origin (i.e., seed broker 100) and at final destination, and may be partially or completely public, private, or some combination thereof. A portion of the seed blockchain 101 may contain a shipping log of each location the logged seeds are shipped to, as well as associated shipping data, which may include, for example, end point location, transfer of custody, data loggers and shipping manifests, in-transit product state from smart packaging or carrier sensors, carrier, route, and environmental data. A seed blockchain log 102 is portion of the seed blockchain 101 containing a log of each seed and associated data, the associated data may include breeder, genetic ID, date the seed was isolated, as well as quality data, such as data relating to quality assurance or quality checks, etc. A seed distribution system 103 is provided for distributing seeds for growing cannabis. A payment module 104 allows growers 107 to pay for cannabis seeds. A unique seed label 105 for a single or multiple cannabis seeds containing all or a portion of the associated blockchain hash, allowing a shipper, extractor 115, product manufacturer, user and/or grower 107 to identify the associated seed data in the seed blockchain 101. A seed database 106 of associated seed data the seed broker 100 may draw from to log the associated seed data in the seed blockchain 101 is provided. Shipping data is created based on notification, seed label 105, and other data from the seed database 106 and is sent to the seed blockchain 101.

A cannabis grower 107 receives seeds from the seed broker 100. The system is capable of verifying the identity of the grower 107, using a passcode, biometrics, private cryptography key and receives verification from the third-party verification network. A plant blockchain 108 ledger that logs plant data, quality data (e.g., data relating to quality assurance or quality checks) and shipping data (e.g., end point location, transfer of custody, data loggers and shipping manifests, in-transit product state from smart packaging or carrier sensors, carrier, route, and environmental data) at the point of origin (e.g., grower 107) and at final destination and may be partially or completely public, private, or some combination thereof. A plant blockchain log 109 is a portion of the plant blockchain 108 containing a log of each plant and associated data, the associated data may include grower 107, grow conditions, soil medium, temperature, nutrients, watering schedule, vegetation and flowering cycles, harvest, trim, and curing times, etc. A portion of the plant blockchain 108 may contain a shipping log of each location the logged plants (or resulting biomass) are shipped to. A growing system 110 for growing cannabis plants. A unique plant label 111 for a single or multiple cannabis plants containing all or a portion of the associated blockchain hash, allowing a shipper, extractor 115, product manufacturer, and/or user to identify the associated plant data in the plant blockchain 108.

A grower database 112 of associated with plant data the grower may draw from to log the associated plant data in the plant blockchain 108 is provided. Shipping data is created based on notification, plant label 111, and other data from the grower database 112 and is sent to the plant blockchain 108. The grower database 112 stores information about the crop and testing parameters. For example, the grower database 112 can store terpene profiles and cannabinoid contents for one or more plants. The one or more plants can be identified by crop number, type, location, and harvest time.

| | | | Harvest Time | Cannabinoid |
|---|---|---|---|---|
| Crop | Type | Location | (days) | Content |
| 0001 | Chinese | 41°24′12.2″N | 94 | 3% |
| | hemp | 2°10′26.5″E | | |
| 0002 | Canadian | 35°18′9.1″N | 120 | 12% |
| | hemp | 4°5′13.2″E | | |

A plurality of plant sensors 113, for example root sensor, bud sensor, environmental sensors, harvest sensors, are provided. The plant sensors 113 are placed at the crop level and/or used for and during harvesting. A plant data module 114 is capable of aggregating the plant sensor 113 data for inclusion in the plant blockchain 108 ledger. The plant data module 114 polls the plant sensors 113 for plant data. The plant data module 114 stores the plant data 113 in the grower database 112 and sends the plant data to the plant blockchain 108.

A cannabis extractor 115 receives cannabis from a grower 107. The system is capable of verifying the identity of the extractor 115, using a passcode, biometrics, private cryptography key, and receives verification from the third-party verification network. An extract blockchain 116 ledger that logs extraction data, quality data (e.g. data relating to quality assurance or quality checks), and shipping data at the point of origin (e.g., extractor 115), and may be partially or completely public, private, or some combination thereof. An extract fork is a module that homogenizes the blockchain hash of incoming biomass destined to be extracted into a homogenized extract, the module includes the seed blockchain 101 and plant blockchain 108 of all inputs used to create the extract, allowing a new blockchain to be generated for the homogenized extract. The extract fork 117 receives plant data from the plant label 111 of incoming biomass for extraction and retrieves the plant data from the plant blockchain log 109. The extract fork 117 calculates a new extract fork 117 based on the retrieved plant data and publishes the new extract fork 117 to the distributed blockchain network. An extract blockchain log 118 is portion of the extract blockchain 116 containing a log of each extract and associated data, the associated data may include extraction parameters, biomass statistics, yield, purity, viscosity, etc., as well as quality data, such as data relating to quality assurance or quality checks throughout the extraction process (e.g. sampling incoming biomass, sampling extract after extraction, sampling after downstream process, or sampling final formulation, for example), etc. A portion of the extract blockchain 116 may contain a shipping log of each location the logged extracts are shipped to, as well as associated shipping data, which may include, for example, end point location, transfer of custody, data loggers and shipping manifests, in-transit product state from smart packaging or carrier sensors, carrier, route, and environmental data. An extraction system 119 for extracting cannabis biomass is provided. A unique extract label 120 for a cannabis extract containing all or a portion of the associated blockchain hash, allowing a shipper, downstream processor, product manufacturer, and/or user to identify the associated extraction data in the extract blockchain 116.

An extraction database 121 of associated extract data the extractor 115 may draw from to log the associated extract data in the extract blockchain 116 is provided. The extraction database 121 contains information regarding the extract (e.g., extract, crop profile), extraction conditions (e.g., extraction type flow conditions (e.g., continuous or batch), extraction time), testing (e.g., purity (e.g., quality of extracted cannabinoids), yield, recovery rate of cannabinoids) and supply chain step (e.g., extract manufacturer).

| | Crop | Extraction | Flow | Extraction | | | Recovery |
|---|---|---|---|---|---|---|---|
| Extract | Profile | Type | Conditions | Time | Purity | Yield | Rate |
| 302 | 20% of | Microwave | Continuous | 3.5 minutes | 60% | 40% | 78% |
| | 0001 | | | residence | | | |
| 402 | 30% of | Microwave | Continuous | 4.5 minutes | 12% | 55% | 83% |
| | 0002 | | | residence | | | |

Shipping data is created based on notification, extract label 120, and other data from the extraction database 121 and is sent to the extract blockchain 116. A plurality of extraction sensors 122 includes a biomass sensor, solvent sensor, extractor sensor, separation filtration sensor, and formulation sensor. A data module 123 is capable of aggregated the extraction sensor 122 data for inclusion in the extract blockchain 116 ledger. The data module 123 polls the extraction sensors 122 for extraction data. The data module 123 stores the extraction data in extraction database 121 and sends the extraction data to extract blockchain 116.

A cannabis product manufacturer that receives extract from the extractor 115. The system is capable of verifying the identity of the product manufacturer, using a passcode, biometrics, private cryptography key, and receives verification from the third-party verification network. A product blockchain 125 ledger that logs manufacturing data and shipping data at the point of origin (e.g., product manufacturer 124), and may be partially or completely public, private, or some combination thereof. A product fork is a module that homogenizes the blockchain hash of incoming concentrate destined to be manufacturer into a product, the module includes the seed blockchain 101, plant blockchain 108, and extract blockchain 116 of all inputs used to create the product, allowing a new blockchain to be generated for the manufacturer product. The product fork receives product data from the product label 129 of incoming product for product manufacturing. The product fork retrieves product data from the manufacture blockchain log and calculates a new product fork based on the retrieved product data and publishes the new product fork to the distributed blockchain network. A manufacture blockchain log is a portion of the product blockchain 125 containing a log of each product and associated data, the associated data may include manufacturing parameters, product statistics, date of manufacture, etc. A portion of the product blockchain 125 may contain a shipping log of each location the logged products are shipped to, as well as associated shipping data, which may include, for example, end point location, transfer of custody, data loggers and shipping manifests, in-transit product state from smart packaging or carrier sensors, carrier, route, and environmental data. A manufacturing system 128 for manufacturing cannabis products. A unique product label 129 for a cannabis product containing all or a portion of the associated blockchain hash, allowing a shipper, further processor, downstream retailer, and/or user to identify the associated product data in the product blockchain 125.

A product database 130 of associated product data the product manufacturer 124 may draw from to log the associated manufacturing data in the product blockchain 125 is provided. The product database 130 contains the product ID, what is in the extract (e.g., THC:CBD 1:1), type (e.g., edible), and point of sale (e.g., yes or no). There are many possibilities for the product database 130, for instance it could include date of product definition, strain or cultivar of cannabis, other cannabis related analysis (e.g., terpenoids, flavonoids, etc.). It could also include process information of extraction. The product database 130 can store information about the final product (e.g., handling data, POS, sourcing locations).

| Product | Extract | Type | POS |
|---|---|---|---|
| P303 | THC:CBD = 1 | Edible | Yes |
| P22 | THC:CBD = 170 | Smokable | No |

Shipping data is created based on notification, product label 129, and other data from the product database 130 and is sent to the product blockchain 125. A plurality of manufacturing sensors 131, for example concentrate sensor, process parameter sensors, packaging sensor, etc. A manufacturing data module 132 is capable of aggregating the manufacturing sensor 131 data for inclusion in the product blockchain 125 ledger. The manufacturing data module 132 polls the manufacturing sensors 131 for manufacturing data and stores the manufacturing data in the product database 130. The manufacturing data module 132 sends the manufacturing data to the product blockchain 125.

A retailer 133 of cannabis products is provided. The system is capable of verifying the identity of the retailer 133, using a passcode, biometrics, private cryptography key, and receives verification from the third-party verification network. A retailer blockchain 134 ledger that logs retailer data and shipping data at the point of sale, and may be partially or completely public, private, or some combination thereof. A transaction blockchain log 135 is portion of the retailer blockchain 134 containing a log of each transaction and associated data, the associated data may include point of purchase, date, payment amount, payment type etc. A portion of the retailer blockchain 134 may contain a shipping log of each location the logged products are shipped to, as well as associated shipping data, which may include, for example, end point location, transfer of custody, data loggers and shipping manifests, in-transit product state from smart packaging or carrier sensors, carrier, route, and environmental data. A retail system 136 for retailing cannabis products is provided. A point of sale terminal 137 capable of providing retail data is provided. A retail database 138 capable of storing retail data is provided. Shipping data is created based on notification, product label 129, and other data from the retail database 138 and is sent to the retailer blockchain 134.

The system includes a user device 142, such as a laptop, smartphone, table, or smart speaker. A blockchain app 144 is an application that allows the user to enter in the unique product hash and retrieve data from the retailer blockchain 134, product blockchain 125, extract blockchain 116, plant blockchain 108, and/or seed broker 100 blockchain. The user scans the seed label 105, product label 129, plant label 111, extract label 120, etc. to obtain a unique hash and queries the distributed blockchain network with the unique hash. The blockchain app 144 receives the public ledger related to hash and parses the public ledger for seed data log, plant data log, extract data log, product data log, retail data log, quality data, shipping data, etc. and displays it on the user device 142. A third-party verification network 140 is capable of verifying the identities of seed brokers 100, growers 107, extractors 115, manufacturers and retailers 133 of cannabis products. The third-party verification network 140 has a verification registry 141 of verifiable seed brokers 100, growers 107, extractors 115, product manufacturers 124, and retailers 133.

A tracking network 146 connects the entire supply chain by receiving and storing data coming from sensors placed at different steps of the supply chain and ensuring the quality of the product as it moves through the different stages of the supply chain. It also groups and organizes the data so once a query is received, the time to process and send the data back is minimized. As part of the sensor data, each broker 100, grower 107, harvester, extractor 115, product manufacturer 124, retailer 133 and consumer are responsible for the data/product information required to run quality control and quality assurance at the platform level. An attribute profile 147 contains all data (e.g., crop profile, geolocation, testing and handling data) from the various databases in the system (e.g., seed database 106, grower database 112, extraction database 121, product database 130, retail database 138, etc.) related to the profile of a cannabis product or extract from seed to sale.

The tracking network 146 can be used to determine the most highly-rated mix of cannabis biomass and handling technique to manufacture a type of edible cannabis concentrate-infused product based on product ratings by consumers. The tracking network 146 stores and allows tracking at any stage of the seed-to-sale process and providing consumers with blockchain data on any product being consumed. A database retrieval module 151 retrieves the unique, immutable see-to-sale data of a specific cannabis biomass, concentrate, or concentrate-infused product from the seed to sale database. The database retrieval module 151 will include retrieving growth conditions for each cannabis biomass, the manufacturing attributes data (e.g., cost of processing and transportation, efficiency rate, etc.), and the finished cannabis-infused product(s) for each biomass. A quality correlation module 152 uses the seed-to-sale database to track the life cycle of a seed and check for inconsistent quality in the product lifecycle based on consumer rating data. In some embodiments, the quality correlation module 152 may flag seed brokers 100, growers 107, extractors 115, and product manufacturers 124 for inconsistent quality. A product optimization module 153 reads in the consumer rating data from the product rating database 155 on all cannabis concentrate-infused cannabis products and based on the seed-to-sale database retrieved by the database retrieval module 151, determine the most highly rated mix of cultivars and the processing techniques to manufacture one type of cannabis product. For example, a manufacturer of edibles would be shown through this system that a mix of cultivars processed in a certain manner makes his candies better, while certain baked goods require a different technique. In some embodiments, the product optimization module 153 matches the desired consumer effects with certain specific attributes in the growth conditions and handling process and makes recommendation to the consumer on the user interface. A user rating module 154 can populate the product rating database 155 with product data retrieved from the seed-to-sale database and product rating database 155 data from the user app 143 on the user device 142. The user rating module 154 retrieves the product data from the seed-to-sale databases through the database retrieval module 151 and updates entries as new products are introduced and retrieves the product rating data from the user app 143 on the user device 142 for each product and stores this data in the product rating database 155.

A product rating database 155 stores the cannabis-infused cannabis product and the corresponding consumer rating data by effects (e.g., organoleptic properties, psychological effects and therapeutic effects) for each product received from the user rating module 154. The product rating database 155 stores many elements of the product, such as product ID, product name, psychoactive effects rating (e.g., relaxation, uplifting, creation), medical effects rating (e.g., stress relief, pain relief) and taste and duration.

| Product | Product | | | | Stress- | Pain- | Long- |
|---|---|---|---|---|---|---|---|
| ID | Name | Relaxation | Uplifted | Creation | relief | relief | lastingness |
| 785489 | Cannabis- | 100 | 50 | 70 | 80 | 50 | 40 |
| | infused | | | | | | |
| | cookie | | | | | | |
| 45436 | Cannaoil | — | — | 60 | — | — | 90 |
| 685435 | Cannabutter | 80 | 50 | 40 | 80 | 50 | 60 |

A monitoring module 148 contains the algorithms that pool new events, identify them and update or add records to each of the databases in the tracking network 146. As an example, grow/harvest sensor sends data (e.g., harvest conditions) from a cannabis grower 107 to the tracking network 146, the monitoring module 148 stores the data in the appropriate database, so it may be queried by the user module 150. The monitoring module 148 receives data from the sensors at remote locations throughout the value chain and polls for new events. The monitoring module 148 identifies the new event (e.g., what database is related to the new event) and records the new information. A quality control module 149 contains the algorithms that pool new events, identify them and update or add records to each of the databases in the tracking network 146. A user module 150 contains a series of algorithms that allow the tracking network 146 to retrieve and send the right information to the user once a query has been submitted. The user module 150 polls the new event, identifies the event, and retrieves the information from the right database. As an example, a product manufacturer 124 (e.g., cannabis pet product) may need an average quality of the cannabis extract because it is not for human consumption. The user module 150 would search the extract database for the quality of extract and the provider's name. As another example, a user of a cannabis product sends a query about a cannabis product from their user device 142, the user module 150 on the tracking network 146 receives the query and identifies the appropriate database to retrieve the content from. The user module 150 retrieves the data relevant to the query and sends the data to the user device 142. The data may include specific information about the cultivar and breeder, the conditions of the growing (e.g., growth medium, indoor/outdoor, etc.), downstream processes, and product manufacturing information. In yet another example, the user can add data back into the tracking system in a structured way. The user may be able to add a) when/where the product was purchased, b) where, when, and how the product was consumed, c) effectiveness of the product (e.g., on a scale of 1-10), d) user recommendations for the same type of product. The user module 150 receives a query from the user device 142 and identifies an event (e.g., what database is related to the new event). The user module 150 polls the databases and creates a master database. The user module 150 retrieves information from the master database and sends quality information to the user device 142.

A user device 142 allows users to register their preferences in the user preference database 145, rate the quality of the cannabis products and send the product rating data to the user rating module 154 in the product tracking network 146, and all the user accounts and their user preference data are stored. A user app 143 is a user application for users to register their preferences in the user preference database 145, rate the quality of the cannabis products and send the product rating data to the user rating module 154 in the product tracking network 146. The user app 143 allows a user to activate a new user account and register product information and rate the product on a metrics and sends the ratings to the user rating module 154. In some embodiments, the user can inquire product information, look up seed-to-sale database for the finished product and inspect every step in the handling and extraction process.

A user preference database 145 is a database that stores the identified consumers, their desired concentrate-infused products, the potency in the desired product, and the biomass used to manufacture the product. The user preference database 145 stores consumer accounts and cannabis concentrate-infused product.

| User Account | Cannabis Product |
|---|---|
| Adam | Low THC-infused lemon custard pie |
| Bob | Cannabis concentrate added orange juice |
| Charlie | Cannaoil |

The cloud 139 or communication network gets user preference data from the user device 142 and enables consumer to make connections, share product reviews and recipes, and allows additional cloud-based service such as recipe subscription. For example, the Blue Apron for Concentrates is a food, recipe and concentrate subscription service that supplies subscribers with cannabis infused recipes, along with food ingredients and a concentrate that is specifically tailored to be used in this recipe.

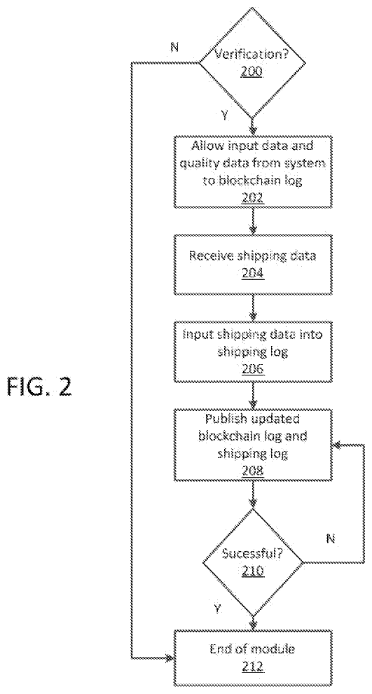

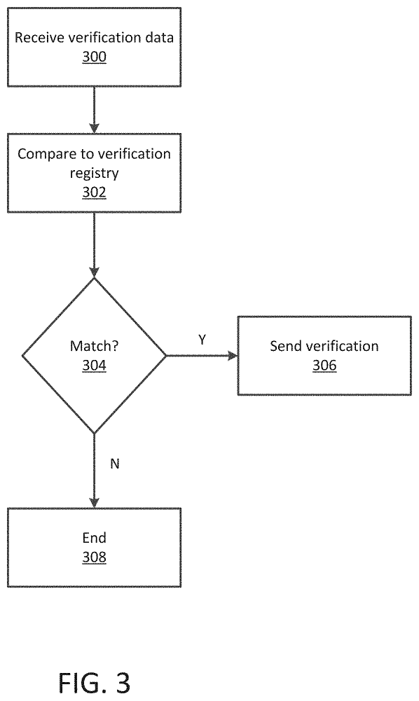

FIG. 2 is a flowchart illustrating an exemplary method for tracking cannabis products using a blockchain-based distributed ledger. The blockchain process is the same for the seed broker 100, the grower 107, the extractor 115, the product manufacturer 124, and the retailer 133. The process begins at step 200 with testing whether verification has been received from the third party verification network, which is further described in FIG. 3.

If verification from the third party verification network 140 is not received, the process goes to step 212 and ends. If verification from the third party verification network 140 is received, the process moves to step 202 and allows data to be input into the blockchain log. For the seed broker 100, seed data and quality data from the seed distribution system is input into the seed blockchain log 102. For the grower 107, plant data and quality data from the growing system 110 is input into the plant blockchain log 109. For the extractor 115, extraction data and quality data from the extraction system 119 is input into the extract blockchain log 118. For the product manufacturer 124, product data and quality data from the manufacturing system 128 is input into the manufacture blockchain log. For the retailer 133, transaction data and quality data from the retail system 136 is input into the transaction blockchain log 135.

At step 204, shipping data (e.g., end point location, transfer of custody, data loggers and shipping manifests, in-transit product state from smart packaging or carrier sensors, carrier, route, environmental data, etc.) is received. At step 206, the shipping data is input to the shipping log in the respective blockchain. At step 208, the updated blockchain log and shipping log is published to the distributed blockchain network. At step 210, it is determined if the blockchain log was published successfully. If the blockchain log was published successfully, the process ends at step 212. If the blockchain log was not published successfully, the process goes back to step 208 and publishes the blockchain log again.

FIG. 3 is a flowchart illustrating an exemplary method for verification of blockchain-based distributed ledgers regarding cannabis products. The process begins at step 300 when the third-party verification network 140 receives the verification ID and verification data (e.g., biometric, passcode, private key) from the seed broker 100, grower 107, extractor, product manufacturer 124, or retailer 133. At step 302, the verification ID and verification data is compared to the verification registry 141. At step 304, it is determined if the verification data matches the verification registry 141. If the verification data matches the verification registry 141, the third party verification sends verification to the seed broker 100, grower 107, extractor 115, product manufacturer 124, or retailer 133 from which the verification data was received at step 306. Otherwise, the process goes to step 308 and ends.

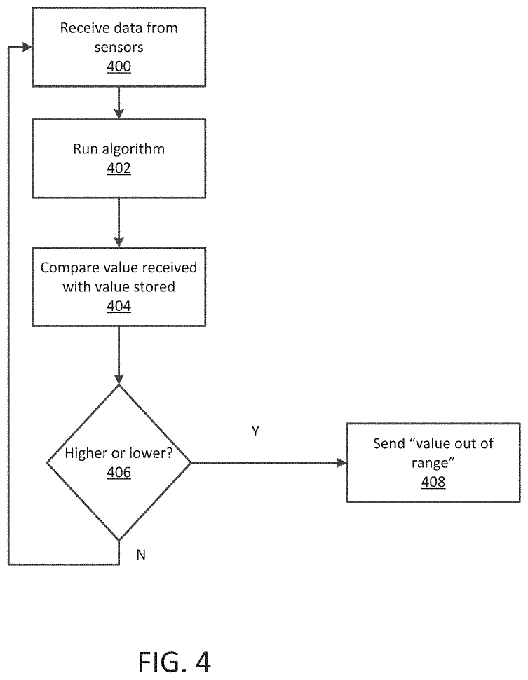

FIG. 4 is a flowchart illustrating an exemplary method for quality control of blockchain-based distributed ledgers regarding cannabis products. The process begins at step 400 with the quality control module 149 receiving data from sensors (e.g., smart tags) once the product/extract is received and sent out for each of the stages of the value chain. At step 402, the quality control module 149 runs algorithms to compare the values received with the values stored in master database. At step 404, the quality control module 149 compares the values received with the values stored in master database. At step 406, the quality control module 149 determines if the value received is higher or lower than the value stored. If the value received is higher or lower than the value stored, the quality control module 149 sends a “value out of range” notification to the stage owner of the value chain. If the value received is not higher or lower than the value stored, the process goes back to step 400 to receive data from the sensors.

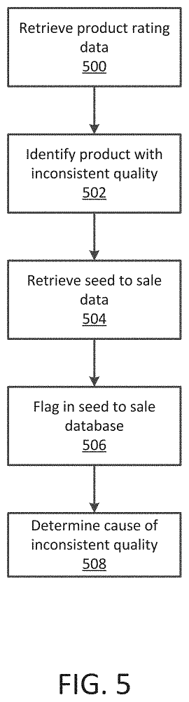

FIG. 5 is a flowchart illustrating an exemplary method for quality correlation using blockchain-based distributed ledgers regarding cannabis products. The process begins at step 500 with the quality correlation module 152 retrieving the product rating data through the user rating module 154. At step 502, the quality correlation module 152 identifies products with inconsistent quality. At step 504, the quality correlation module 152 retrieves the seed-to-sale data through the database retrieval module 151 for each product. At step 506, the quality correlation module 152 checks the seed-to-sale blockchain data at every “checkpoint” (e.g., grower 107, cultivar, growth conditions, harvesting conditions, post-harvesting handling techniques, extraction processor, extraction method, concentrates profiles, final cannabis products) and flags seed brokers 100, growers 107, extractors 115, and product manufacturers 124 for inconsistent quality. At step 508, the quality correlation module 152 determines the relevant agencies of custody that caused the inconsistent quality.

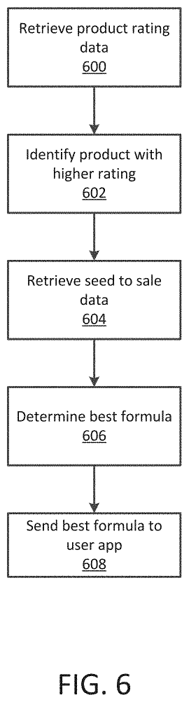

FIG. 6 is a flowchart illustrating an exemplary method for product optimization using blockchain-based distributed ledgers regarding cannabis products. The process begins at step 600 with the product optimization module 153 retrieving product rating data through the user rating module 154 for each product. At step 602, the product optimization module 153 identifies products with higher ratings (e.g., top 10% of rated products in the same type of product). At step 604, the product optimization module 153 retrieves the seed-to-sale data through the database retrieval module 151 for each product. At step 606, the product optimization module 153 determines the best cannabis cultivar or mix of cannabis cultivars, growers 107, extraction processors and handling techniques by using the mostly repeated formulae among the highly-rated products or dynamically combining two or more formulae. In one example a large group of mixes of cannabis cultivars shows a specific temperature range has been widely used. Therefore, any time the particular cannabis cultivar is used, a manufacturer can set a rule in the database to send a flag or alert if they set there process out of the common temperature range. At step 608, the product optimization module 153 sends the best formula to the user app 143 on the user device 142.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claims.

What is claimed is:

1. A system for tracking an extractable biomass, the system comprising:
a plurality of stage systems each associated with a different stage in an extractable biomass product supply chain that includes a plurality of stages, wherein each stage system has a stage database;
a tracking network, comprising:
a plurality of sensors placed at the different stage systems, each sensor capturing sensor data at the respective stage system, and
an attribute profile that includes data from the one or more stage databases;
a blockchain-based distributed ledger associated with at least one of the stage systems in the extractable biomass product supply chain, the distributed ledger including data from the stage database of the at least one stage system and the sensor data regarding the at least one stage system; and
a third-party verification network receives a verification request regarding the extractable biomass product and verifies one or more identities of the one or more stage systems in the supply chain based on the blockchain-based distributed ledger.

2. The system of claim 1, further comprising a user device application executable to activate a new user account and to register product information regarding the extractable biomass product.

3. The system of claim 2, wherein the user device application receives product rating data regarding the extractable biomass product and sends the product rating data to the blockchain-based distributed ledger for the extractable biomass product.

4. The system of claim 2, wherein the user device application includes a blockchain application executable to scan one or more labels to obtain a unique hash associated with the extractable biomass product.

5. The system of claim 3, wherein the user device application is associated with a user preference database that stores one or more user accounts and one or more preferred products registered by the one or more user accounts.

6. The system of claim 1, wherein the third-party verification network verifies the one or more identities based on matching verification data to a verification registry.

7. The system of claim 1, wherein the tracking network further includes a product rating database that stores one or more product ratings from one or more users.

8. The system of claim 7, wherein the tracking network further includes a monitoring module that polls the sensors placed at the different stages in the supply chain, the sensors polled for new data events.

9. The system of claim 8, wherein the tracking network further comprises a user module executable to:
receive a query regarding the extractable biomass product;
create a master database based on the query; and
send data from the master database in response to the query.

10. The system of claim 9, wherein the tracking network further comprises a database retrieval module executable to retrieve data from the one or more stage databases.

11. The system of claim 10, wherein the tracking network further comprises a quality control module executable to compare the sensor data with the data in the master database;
determine if the value is out of range; and
send a message to the at least one stage owner in the supply chain.

12. The system of claim 11, wherein the tracking network further comprises a user rating module executable to:
receive information regarding the extractable biomass product when the extractable biomass product is introduced;
retrieve product rating data associated with the extractable biomass product; and
store the product rating data in a product rating database.

13. The system of claim 12, wherein the tracking network further comprises a quality correlation module executable to retrieve product data via the user rating module;
identify one or more products with inconsistent quality indicated by the retrieved product data;
receive data via the database retrieval module; and
determine which of the stage owners is associated with the products identified as having inconsistent quality.

14. The system of claim 13, wherein the tracking network further comprises a product optimization module executable to:
identify one or more products with ratings falling in a high level in comparison to other rated products; and
determine a formula associated with the products with the high level ratings.

15. A method for tracking an extractable biomass, the method comprising:
verifying one or more identities of one or more stage owners in the in a supply chain in a distributed blockchain network;
allowing the one or more stage owners to log data in one or more blockchains;
homogenizing the one or more blockchains; and
allowing one or more users to retrieve data from the one or more blockchains.

16. The method of claim 15, wherein homogenizing the one or more blockchains is done by:
receiving data from one or more labels;
retrieving the data from a blockchain log in the blockchain;
calculating a new blockchain fork; and
publishing the new blockchain fork to the distributed blockchain network.
